(19) United States
(12) Patent Application Publication
(10) Pub. No.: US 2007/0168921 A1
(43) Pub. Date: Jul. 19, 2007

(54) Method for automatic recovery of uml model requirements and updating thereof

(76) Inventors: Arnaud Bailleul, Toulouse (FR); Eric Halbeher, Tournefeuille (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/583,367

(22) PCT Filed: Dec. 8, 2004
(86) PCT No.: PCT/EP04/53341

§ 371 Date: Jun. 19, 2006

(30) Foreign Application Priority Data
Dec. 19, 2003 (FR) 03 15036

(51) Int. Cl. G06F 9/44

(52) U.S. Cl. 717/104

(57) ABSTRACT

The present invention relates to a method of automatic uploading of the requirements of UML models and of their updating, and according to a characteristic of the invention, the requirements are created during the creation of the elements of the UML model, that, when the model is stabilized, it is exported to the requirements management tool, thus creating, automatically, a navigation module containing all the UML objects pointed at by at least one requirement and a requirements module of level n that may itself be linked subsequently to other requirements modules. In particular the link with the upstream requirement module of level n+1 will be able to be automated by virtue of the DOORS TREK utility “Create links by key . . . ”.

The present invention pertains to a method of automatic uploading of the requirements of UML models created by a modeling tool, and of their updating.

When modeling a project, whatever it may be, use is currently made, in a preferential manner, of the UML language, implemented in a modeling tool, such as “RHAPSODY” from the company I-LOGIX. The modeling requires the consideration of requirements, and for this purpose, a requirements management tool such as “DOORS” from the company TELELOGIC is made available. However, there does not exist any means making it possible to ensure the traceability of the information of the model so as to keep the requirements management tool informed thereof.

The present invention is aimed at a method of automatic uploading of the requirements of UML models to a requirements management tool so as to allow their updating, doing so without limitation on the placement of requirements and their number.

The method in accordance with the invention is characterized in that the requirements are created during the creation of the elements of the UML model, that once the model has been stabilized, the requirements entered into the model are exported to the requirements management tool and there is created automatically a navigation module containing all the UML objects pointed at by at least one requirement and a requirements module of level n. Advantageously, the requirements module of level n is linked to another upstream requirements module of level n+1 defined previously.

The present invention will be better understood on reading the detailed description of an embodiment, taken by way of nonlimiting example and illustrated by the appended drawing, in which:

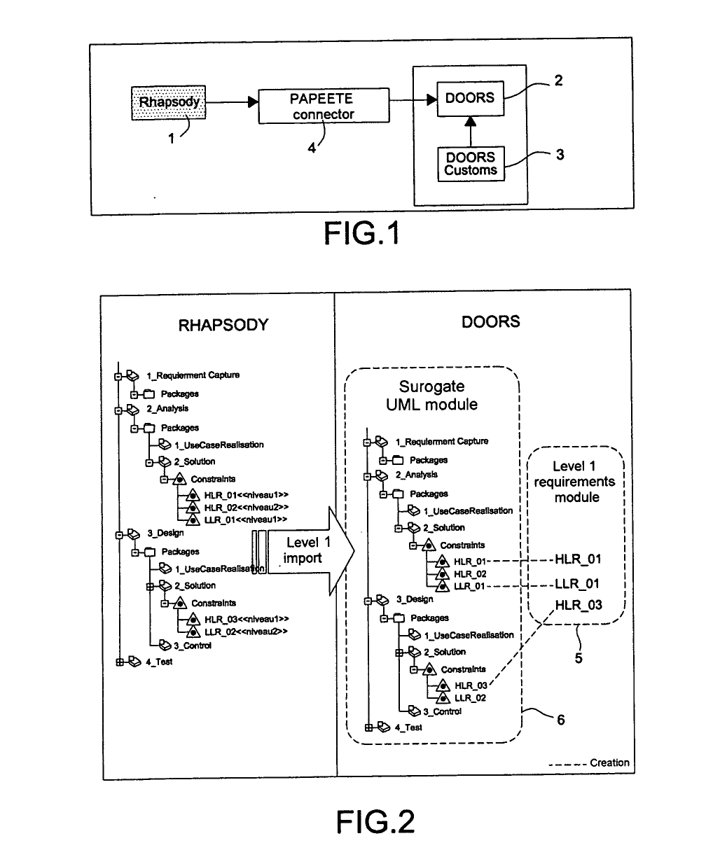

FIG. 1 is a simplified block diagram of an exemplary implementation of the method of the invention,

FIG. 2 is a chart illustrating the first importation of a UML model into a requirements manager, according to the method of the invention,

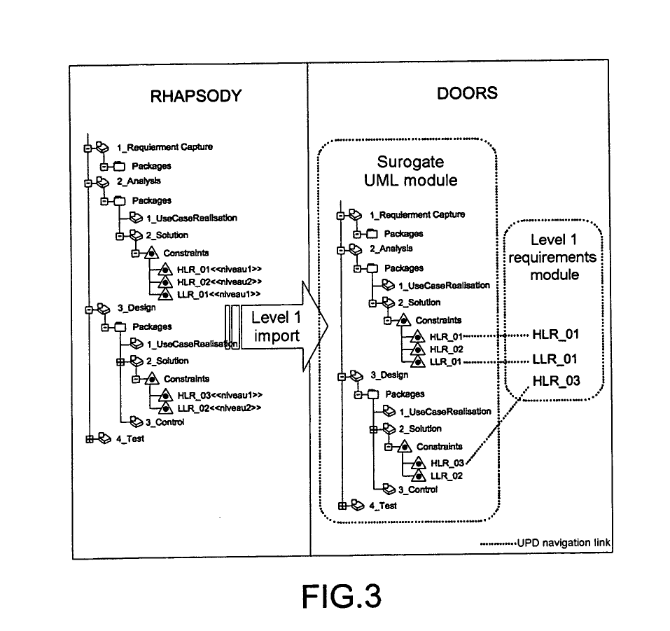

FIG. 3 is a chart illustrating a new importation, under the same conditions (import level 1) as in FIG. 2,

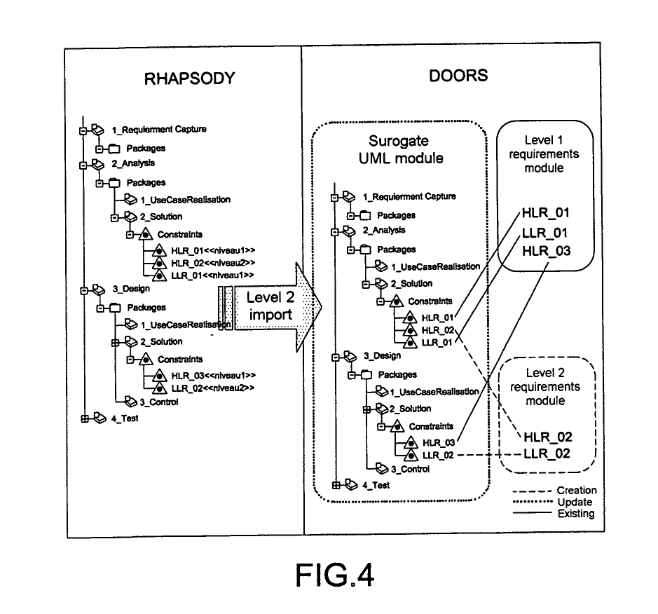

FIG. 4 is a chart illustrating a new importation of a UML model, but at a different level (level 2) from that of FIG. 3,

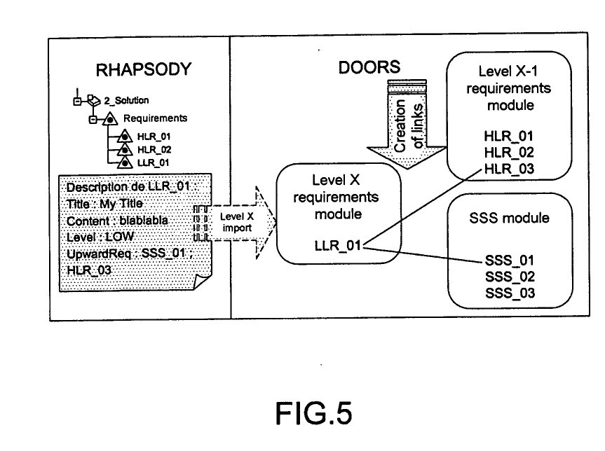

FIG. 5 is a chart illustrating the automatic placing of traceability links from the module to other DOORS modules according to the method of the invention,

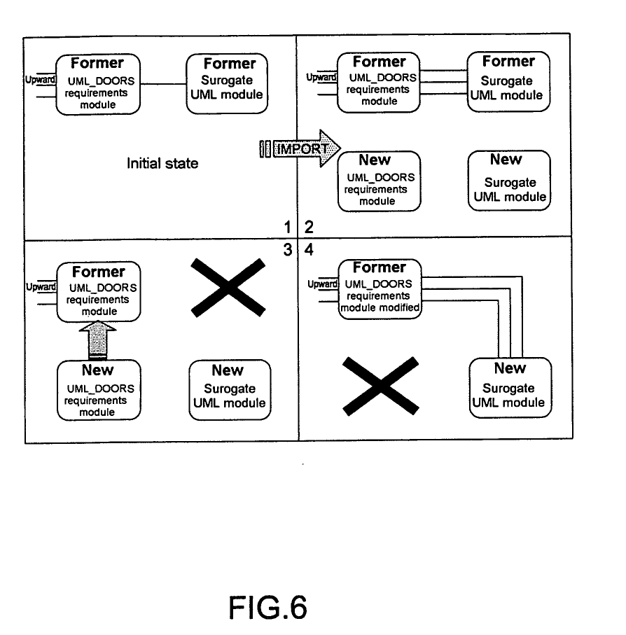

FIG. 6 is a chart in four steps, illustrating the successive operations intervening during a new iteration of importing of a UML model into a requirements manager, according to the method of the invention, and

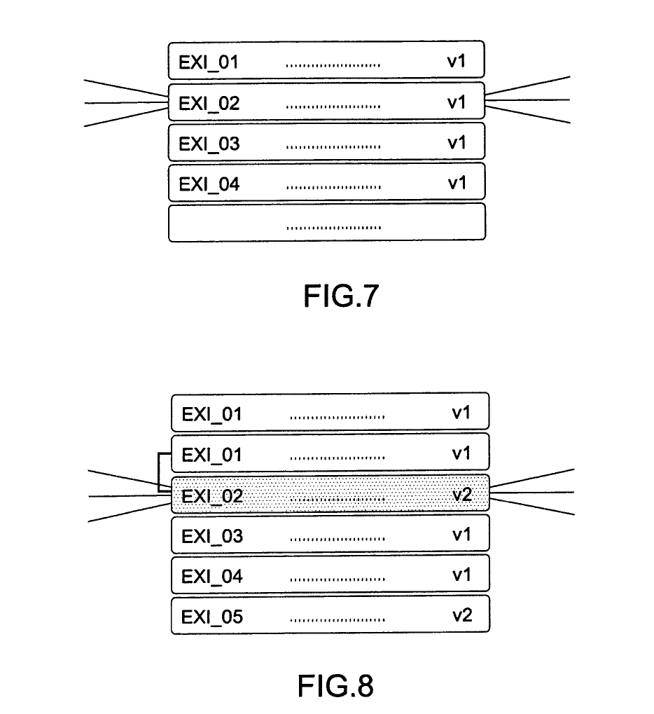

FIGS. 7 and 8 are charts showing two states of a Requirements module of the requirements manager, respectively before and after a new importation, according to the method of the invention.

Represented in FIG. 1 are the main elements of the architecture of the system implementing the invention. These elements are: a UML modeler (1), which is, preferably, the “RHAPSODY” tool, a tool (2) for managing UML Requirements, which is, in the present case, the “DOORS” tool, a workshop of utilities (3), which is here “DOORS Custom” from the company THALES AVIONICS and a universal inter-tools connection connector (4) “PAPEETE” (forming the subject of a patent application from the company THALES). The importation of UML models into the DOORS tool from the RHAPSODY tool is done in the following manner. During the first importation of a UML model from RHAPSODY to DOORS (see FIG. 2), there is creation of two modules in DOORS:
A module (5) of UML_DOORS Requirements corresponding to the specification level (level 1 for the example represented). This DOORS module contains the set of UML_DOORS Requirements which represent the stereotyped UML Requirements with the specification level chosen during the importation. This module 5 here contains the level 1 requirements of the model. These requirements are, for this example: HLR_01, LLR_01 and HLR_03.
A UML navigation module (Surrogate UML Module) (6): this DOORS module contains a representation of the set of UML elements of the model created in RHAPSODY. This representation is in the form of reference to the UML elements. This module has as objective to allow navigation between RHAPSODY and DOORS (as set out in the “DOORS Custom User Guide” manual).

The following importations of the same UML model can be of two different types. Either, as represented in the example of FIG. 3, it involves the same specification level as previously (level 1 in this instance). In this case, at one and the same time the UML_DOORS Requirements Module and the UML navigation Module are updated as a function of the modifications made to the UML model. Or, as represented in FIG. 4, they pertain to a different specification level (level 2 in this instance, involving the requirements HLR_02 and LLR_02). In this case, there is creation of a UML_DOORS Requirements module corresponding to the specification level selected (level 2) during the importation and updating of the UML navigation Module as a function of the modifications made to the model.

The links between a UML_DOORS Requirement and its representation in the UML navigation Module are created automatically during the importation of the UML model under DOORS. These links allow navigation between the two tools RHAPSODY and DOORS.

The creation of links to other DOORS requirements modules is carried out in the following manner. After having performed an importation of a RHAPSODY model into DOORS, it is possible to automatically create the links between Requirements of the module created automatically and Requirements of another DOORS module or those of another module created automatically previously. This automatic creation of links is performed with the DOORS TREK utility “Create links by key . . . ”. Thus, as represented in FIG. 5, during the importation of the specification level X, traceability links are created between the Requirements module of level X and, on the one hand, the requirements module of level X−1, and on the other hand a module of quite another requirements specification level (SSS in this case).

The management of the modifications made to the requirements relating to the UML model is carried out in the following manner.

The management of the modifications of the requirements implies the capacity to navigate between the RHAPSODY tool and the DOORS tool. Specifically, it is necessary to be capable of rapidly analyzing the impact of modifications of the upstream requirements on the UML model so as to apply the appropriate modifications to the elements implicated by this impact and conversely.

To carry out the modification of UML_DOORS Requirements, it is not necessary to modify under DOORS the attributes of the UML_DOORS Requirements specified in the UML Requirements (as explained in the Guide to UML requirements modeling). These modifications must be performed only in the UML model under RHAPSODY.

Subsequent to a modification of DOORS Requirements, for each UML-DOORS Requirement which refines it (as explained in the DOORS Guide) it is necessary to:
1. navigate, with the aid of the DOORS/RHAPSODY navigation tool, to the associated UML Requirement,
2. analyze the impact on the modeling of the modification to be performed,
3. update the model
4. update the UML Requirement in the model,
5. import the modified model under DOORS,
6. update the requirements management attributes under DOORS,

Any model modification must be performed taking account of the UML Requirements which have a repercussion on the elements modified so as to maintain consistency between the UML Requirements and the UML model.

To do this, for each modified UML element it is necessary to consult the set of UML Requirements which have a repercussion thereon, so as to verify that these requirements are always consistent with the modification performed on the element.

To manage the changes to a model manifested by successive modifications, the mechanism of successive importations is firstly examined. The importation of a UML model under DOORS is performed in several steps. These steps are invisible to the user, since they are performed in one go during importation. The main steps of this mechanism of successive importations have been illustrated in FIG. 6. This figure comprises four charts (referenced 1 to 4).

In the initial state (1), we have, in DOORS, a UML_DOORS Requirements module linked to a UML navigation module (by navigation links), these modules generated automatically during an earlier importation are dubbed “former”.

When a request to import the UML model aimed at an updating of these two modules arrives, the following actions are engaged:
creation of two new modules (2):
   a UML_DOORS Requirements Module containing the set of UML_DOORS Requirements corresponding to all the UML Requirements contained in the new UML model imported,
   a UML navigation module representing the new UML model,
deletion of the former UML navigation module and of all the DOORS elements relating to it (3),
analysis of the updates to be performed between the two UML_DOORS Requirements Modules,
updating of the former UML_DOORS Requirements Module (4),
deletion of the new UML_DOORS Requirements Module (4),
creation of the navigation links between the former UML_DOORS Requirements Module and the new UML navigation Module.

The user must thereafter update the links for traceability with the upstream requirements. This step is not included in the importation of the UML model, but must be performed separately after each importation with the aid of the DOORS TREK utility “Create links by key . . . ”.

The management of the changes can thereafter relate to the addition of requirements. If a UML Requirement is added to the model, there will be, during the following importation, for one and the same specification level, and one and the same UML model, creation of a new DOORS object in the corresponding UML navigation Module and in the corresponding UML navigation Module.

By way of simplified example, represented in FIG. 7 is the state of the UML_DOORS Requirements Module before a new importation, and which comprises the Requirements EXI_01 to EXI_04 (in version v1). Represented in FIG. 8 is the state of this Module after a new importation, EXI_02 being modified (coexisting versions v1 and v2), and with a new Requirement EXI_05 (version v2).

Likewise, if a UML Requirement already imported during a previous importation is deleted from the model, during the following importation, the UML_DOORS Requirement corresponding to the UML Requirement, will not be deleted from the UML_DOORS Requirements Module, but will take the status “OBSOLETE” and all its DOORS links will be destroyed.

If a UML Requirement already imported during a previous importation is modified in the model, there will be, during the following importation:
creation of a new UML_DOORS Requirement corresponding to the UML Requirement
creation of a link between the former and the new UML_DOORS Requirement
transfer of the incoming and outgoing links from the former to the new UML_DOORS Requirement
updating of the version number on the new UML_DOORS Requirement with respect to the former.
   A journal of the modifications of requirements is thus obtained.

In conclusion, the method of the invention makes it possible to upload automatically under DOORS all the traceability information entered into the UML model. It automatically organizes under DOORS the whole process necessary for navigation between the two tools via the connector PAPEETE or an XML link (or equivalent). Finally it automatically organizes the whole updating of the modules during the various changes to the UML model.

1-6. (canceled)

7. A method of automatic uploading of the requirements of UML models created by a modeling tool, and updating the UML models, created creating during the creation of the elements of the UML model, comprising the steps of: when the model is stabilized, exporting the requirements entered into the model to a requirements management tool, automatically creating a navigation module including all the UML objects pointed at by at least one requirement and a requirements module of level n.

8. The method as claimed in claim 7, wherein the requirements module of level n is linked to another upstream requirements module of level n+1 defined previously.

9. The method as claimed in claim 7, wherein during requirements modifications, these modifications are performed in the UML model, with the modeling tool.

10. The method as claimed in claim 7, wherein the modeling tool is “RHAPSODY” and that the requirements management tool is “DOORS”.

11. The method as claimed in claim 10, wherein during successive importations the following steps are carried out creation of two new modules:
a UML_DOORS Requirements Module containing the set of UML_DOORS Requirements corresponding to all the UML Requirements contained in the UML model imported, and
a UML navigation module representing the new UML model, deletion of the former UML navigation module and of all the DOORS elements relating to it, analysis of the updates to be performed between the two UML_DOORS Requirements Modules, updating of the former UML_DOORS Requirements Module, deletion of the new UML_DOORS Requirements Module, creation of the navigation links between the former UML_DOORS Requirements Module and the new UML navigation module.

12. The method as claimed in claim 10, wherein if a UML Requirement already imported during a previous importation is modified in the model, there will be, during the following importation:
creation of a new UML_DOORS Requirement corresponding to the UML Requirement;
creation of a link between the former and the new UML Requirement;
transfer of the incoming and outgoing links from the former to the new UML-DOORS Requirement;
updating of the version number on the new UML_DOORS Requirement with respect to the former.
